(19) United States
(12) Patent Application Publication
(10) Pub. No.: US 2022/0293006 A1
(43) Pub. Date: Sep. 15, 2022

(54) INFORMATION PROCESSING DEVICE, CONTROLLING METHOD AND RECORDING MEDIUM

(71) Applicant: CASIO COMPUTER CO., LTD., Tokyo (JP)

(72) Inventor: Hiroki ATSUMI, Tokyo (JP)

(73) Assignee: CASIO COMPUTER CO., LTD., Tokyo (JP)

(21) Appl. No.: 17/678,173

(22) Filed: Feb. 23, 2022

(30) Foreign Application Priority Data
Mar. 15, 2021 (JP) 2021-041678

(51) Int. Cl. G09B 19/02; G06F 3/02; G09B 7/04; G06F 15/02

(52) U.S. Cl. CPC G09B 19/025; G06F 3/0219; G09B 7/04; G06F 15/0225

(57) ABSTRACT

Provided is an information processing device which includes a storage unit which has a first storage area for storing a workbook which contains problems which are to be solved by using a calculation formula which contains a function and correct answers to each of the problems, a time counting unit which measures a time interval between two pieces of input information which are input in a case where one calculation formula which is used for solving one problem which is selected from the problems in the workbook is input by an input unit and at least one control unit which makes a display unit display learning progress information which indicates a level of understanding the function on the basis of the time interval between the input information which indicates the function which is contained in the calculation formula and the input information which is input before inputting of that input information.

### BACKGROUND OF THE INVENTION

### Field of the Invention

The present invention relates to an information processing device, a controlling method and a recording medium.

### Related Art

In recent years, spread of learning which utilizes an information processing device such as a smartphone, a tablet-type personal computer and so forth has been promoted. An on-line learning support system which decides a learner's level of understanding on the basis of an answer that the learner gives to a problem which is displayed on a learner's terminal, a time which is taken for solving the problem and so forth is described in, for example, Japanese Patent Application Laid-Open No. 2005-55550.

In addition, in school classes and so forth, there are cases where the learner uses a calculator which is called a scientific calculator. A scientific calculator which is described in this specification includes, for example, an information processing device which executes an application program which makes it possible to carry out a calculation and so forth of a calculation formula which contains functions.

However, in existing learning systems which utilize the scientific calculators, there are many cases where only whether an answer to a problem is correct or incorrect is regarded as an evaluation object. For this reason, it is impossible for the existing learning systems which utilize the scientific calculators to decide and analyze the learner's level of understanding in a thinking process.

### SUMMARY OF THE INVENTION

An information processing device according to one aspect of the present invention includes a storage unit which has a first storage area for storing a workbook which contains problems which are to be solved by using a calculation formula which contains a function and correct answers to each of the problems, a time counting unit which measures a time interval between two pieces of input information which are input in a case where one calculation formula which is used for solving one problem which is selected from the problems in the workbook is input by an input unit and at least one control unit which makes a display unit display learning progress information which indicates a level of understanding the function on the basis of the time interval between the input information which indicates the function which is contained in the calculation formula and the input information which is input before inputting of that input information.

A controlling method according to one aspect of the present invention includes the steps of making a storage unit store a workbook which contains problems which are to be solved by using a calculation formula which contains a function and correct answers to each of the problems into a first storage area thereof, measuring a time interval between two pieces of input information which are input in a case where one calculation formula which is used for solving one problem which is selected from the problems in the workbook is input by an input unit and making a display unit display learning progress information which indicates a level of understanding the function on the basis of the time interval between the input information which indicates the function which is contained in the calculation formula and the input information which is input before inputting of that input information.

A recording medium according to one aspect of the present invention is a non-transitory computer-readable recording medium for recording a program which is executable by at least one control unit in an information processing device which includes a storage unit, in which the storage unit includes a first storage area for storing a workbook which contains problems which are to be solved by using a calculation formula which contains a function and correct answers to each of the problems, and the at least one control unit makes a time counting unit measure a time interval between two pieces of input information which are input in a case where one calculation formula which is used for solving one problem which is selected from the problems in the workbook is input by an input unit and makes a display unit display learning progress information which indicates a level of understanding the function on the basis of the time interval between the input information which indicates the function which is contained in the calculation formula and the input information which is input before inputting of that input information.

### BRIEF DESCRIPTION OF THE DRAWINGS

FIG. 1 is a front view illustrating one example of an external appearance of a scientific calculator according to one embodiment of the present invention.

FIG. 2 is a block diagram illustrating one example of a functional configuration of the scientific calculator according to one embodiment of the present invention.

FIG. 3 is a flowchart explaining one example of processing that the scientific calculator according to one embodiment of the present invention performs.

FIG. 4 is a diagram explaining one example of a leaning method which is performed by using the scientific calculator according to one embodiment of the present invention.

FIG. 5 is a diagram showing one example of a result list.

FIG. 6 is a diagram showing display example of learning progress information.

### DETAILED DESCRIPTION OF THE INVENTION

In the following, one embodiment of the present invention will be described with reference to the drawings. Incidentally, in the following description, as one example of an information processing device according to one embodiment of the present invention, a calculator which is called a scientific calculator will be given. In the following description, detailed description on well-known functions, configurations, operations and so forth of the scientific calculator are omitted.

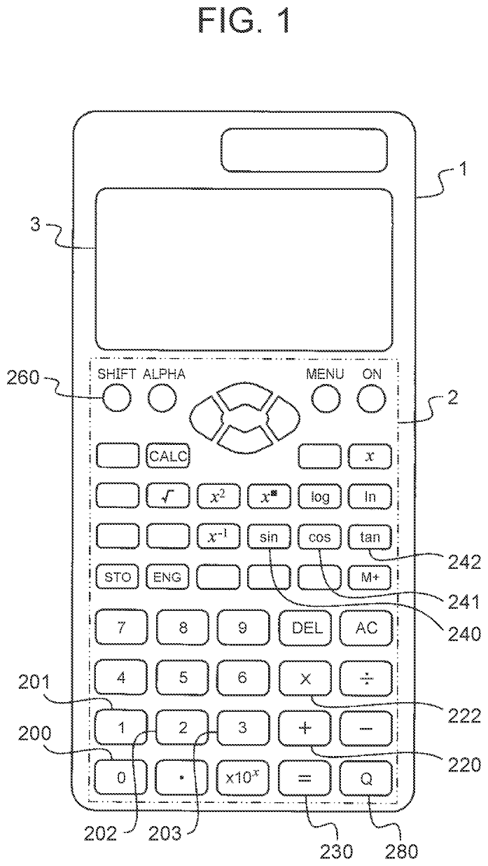

FIG. 1 is a front view illustrating one example of an external appearance of a scientific calculator according to one embodiment of the present invention. In the scientific calculator 1 which is illustrated in FIG. 1, a key arrangement unit 2 and a display 3 are installed on one surface of a housing thereof.

A plurality of keys (for example, hardware keys) such as a key which is used for inputting each numerical value, a key which is used for inputting each operator of Four arithmetic operations, a function key which is used for a calculation of a predetermined function such as trigonometric functions and so forth are arranged on the key arrangement unit 2.

The key which is used for inputting each numerical value includes a 0-input key 200 which is used for inputting “0”, a 1-input key 201 which is used for inputting “1”, a 2-input key 202 which is used for inputting “2”, a 3-input key 203 which is used for inputting “3” and other numerical value input keys. The key which is used for inputting each operator of the Four arithmetic operations includes an addition key 220 which is used for inputting an arithmetic operator “+” for an addition, a multiplication key 222 which is used for inputting an arithmetic operator “×” for a multiplication and other arithmetic operator keys. In addition, in the scientific calculator 1 which is illustrated in FIG. 1, an equal key 230 which is used for inputting “=(equal)” which is adapted to complete inputting of a calculation formula is arranged in the vicinity of the keys which are used for inputting the operators of the Four arithmetic operations.

The function key which is used for the calculation of the predetermined function includes a sin-key 240 which is used for performing a Sine (sin) calculation, a cos-key 241 which is used for performing a Cosine (cos) calculation and a tan-key 242 which is used for performing a Tangent (tan) calculation. In addition, the function key further includes keys which are used for performing calculations of logarithms (log, ln and so forth) and so forth.

In addition, a learning key 280 which is used for execution of learning for solving a problem by utilizing the scientific calculator 1 is arranged on the scientific calculator 1 according to one embodiment of the present invention.

A plurality of functions (performance features) is allocated to some keys which are arranged on the key arrangement unit 2 so as to make it possible to select one of the plurality of functions (performance features) by combining these some keys with, for example, a shift key 260 and a function key (not illustrated). For example, in a case where the shift key 260 is pressed and then the sin-key 240 is pressed, it becomes possible to calculate inverse functions (denoted as sin−1, arcsine and so forth) of Sine.

The display 3 is a display element which displays the calculation formula and a calculation result thereof which are input by utilizing the keys on the key arrangement unit 2, a menu screen and so forth. The display 3 is, for example, a dot-matrix type liquid crystal display and so forth.

It is possible for a user (a learner) to input the calculation formula which contains the functions such as the trigonometric functions and so forth into the scientific calculator 1 which is illustrated in FIG. 1 by pressing the keys which are arranged on the key arrangement unit 2 and thereby to make the scientific calculator 1 perform a calculation in accordance with that calculation formula. The calculation formula and a calculation result which are input are displayed on the display 3.

In addition, when pressing a learning key 280, it becomes possible for the user (the learner) to solve a problem by utilizing the scientific calculator 1 which is illustrated in FIG. 1. In a case where the learning key 280 is pressed, the problem which is to be solved by utilizing, for example, the trigonometric functions is displayed on the display 3. Then, in a case where the user (the learner) of the scientific calculator 1 inputs the calculation formula which is used for solving the displayed question, the result of calculation which is performed in accordance with the input calculation formula and a result of decision as to whether the calculation result is correct or incorrect are displayed on the display 3. Further, as will be described later, it is possible for the scientific calculator 1 according to one embodiment of the present invention to decide and analyze a learner's understanding level on the basis of a time interval between key-input operations which are performed when the learner inputs the calculation formula.

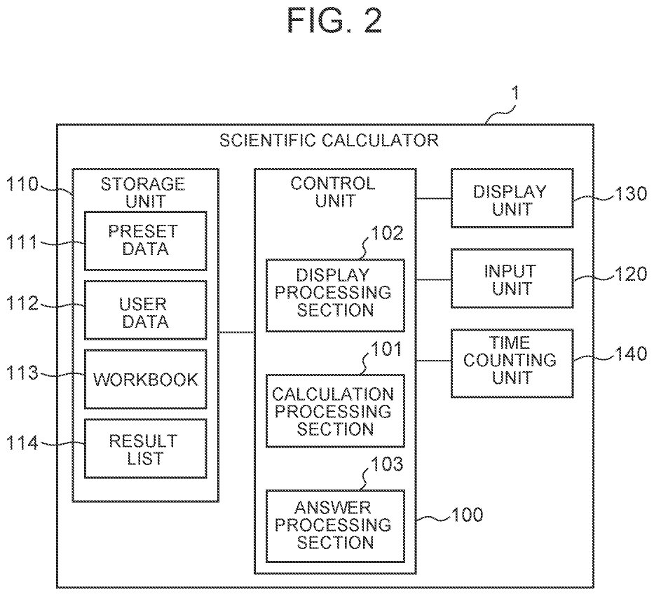

FIG. 2 is a block diagram illustrating one example of a functional configuration of the scientific calculator according to one embodiment of the present invention.

As illustrated in FIG. 2, the scientific calculator 1 according to one embodiment of the present invention includes a control unit 100, a storage unit 110, an input unit 120, a display unit 130 and a time counting unit 140. The input unit 120 corresponds to the plurality of keys on the above-described key arrangement unit 2 and the display unit 130 corresponds to the above-described display 3. The input unit 120 may include a digitizer (a position detector) which is arranged, for example, in superposition on a display region of the display unit 130 (the display 3), not limited to the above-described hardware keys.

The control unit 100 controls operations of the entire scientific calculator 1. The control unit 100 includes a calculation processing section 101, a display processing section 102 and an answer processing section 103. The calculation processing section 101 performs various processes such as a numerical-value calculation process, a program preparation process and so forth on the basis of input information which is input by the input unit 120. The display processing section 102 controls display of the input information which is input by the input unit 120, results of the processes that the calculation processing section 101 performs and so forth on the display unit 130. The answer processing section 103 performs processes which relate to an answer of the user (the learner) of the scientific calculator 1 to the problem which is displayed on the display 3. The answer processing section 103 measures and holds the time interval between the key-input operations that the learner performs, for example, when inputting the calculation formula for solving the problem. In addition, the answer processing section 103 makes decision (in the following, referred to as the “correct/incorrect decision”) as to whether the result of calculation which is performed in accordance with the calculation formula that the learner inputs is correct or incorrect. The answer processing section 103 derives information (learning progress information) which indicates the learner's level of understanding in a thinking process when the learner solves the problem on the basis of the time interval between the key-input operations that the learner performs when inputting the calculation formula. In this case, the answer processing section 103 derives the learning progress information which indicates the learner's level of understanding, for example, in a state of being correlated with the correct/incorrect decision of the calculation result. The learning progress information that the answer processing section 103 derives is displayed on the display unit 130 by the display processing section 102. In addition, in the scientific calculator 1 according to one embodiment of the present invention, for example, it is also possible to store the learning progress information which is derived every time that the learner solves each problem into the storage unit 110 and to display the stored learning progress information on the display unit 130 in a time series. More specifically, it is possible for the scientific calculator 1 to make the display 130 display the learning progress information which indicates the learner's level of understanding the problem which is solved by inputting the calculation formula which contains the predetermined function on the display unit 130 in the time series.

Functions (performance features) of the above-described respective sections of the control unit 100 are realized by a general-purpose processor such as, for example, a CPU (Central Processing Unit) which executes several programs and so forth. Some of the functions (the performance features) of the above-described respective sections of the control unit 100 may be realized also by, for example, an FPGA (Field Programmable Gate Array), an ASIC (Application Specific Integrated Circuit) and so forth. The control unit 100 may be realized either by one hardware processor or by a combination of two or more hardware processors.

The storage unit 110 stores various kinds of information which relate to the operations of the scientific calculator 1. The storage unit 110 which is illustrated in FIG. 2 includes a first storage area, a second storage area, a third storage area and a fourth storage area. Data (preset data) 111 such as, for example, functions, programs and so forth which are prepared in advance is stored in the first storage area. Data (user data) 112 such as, for example, functions, programs, tables and so forth that the user of the scientific calculator 1 prepares is stored in the second storage area. Data (a workbook) 113 which contains problems to be provided to the user (the learner) of the scientific calculator 1, methods of solving these problems (calculation formulae to be used) and correct answers to these problems is stored in the third storage area. Data (a result list) 114 which contains result information which indicates each result that the user of the scientific calculator 1 solves each problem in the workbook is stored in the fourth storage area. As will be described later, the result list 114 contains information which is correlated with a learning progress status and which relates to the time interval between the key-input operations that the learner performs when the learner inputs the calculation formula which is used for solving the problem concerned.

The storage unit 110 includes a ROM (Read Only Memory) and a RAM (Random Access Memory). That is, the storage unit 110 is not one memory (one storage) which includes all the first storage area, the second storage area, the third storage area and the fourth storage area but is realized by a combination of a plurality of memories. It is also possible to utilize a memory such as, for example, a buffer and so forth which are to be built in a processor as part of the storage unit 110.

The time counting unit 140 measures the time interval between the key-input operations that the learner performs when the user inputs the calculation formula which is used for solving the problem concerned.

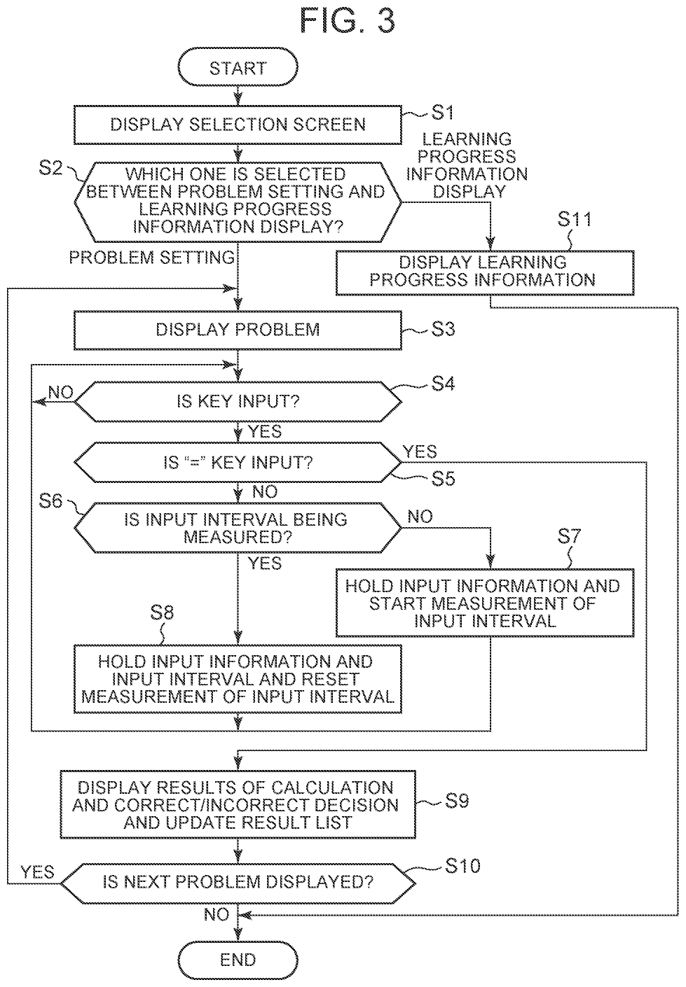

It is possible for the user of the scientific calculator 1 according to one embodiment of the present invention to solve the problem which is displayed on the scientific calculator 1 by pressing the learning key 280 as described above. When the learning key 280 is pressed, the scientific calculator 1 performs processing such as, for example, processing which is illustrated in FIG. 3.

FIG. 3 is a flowchart explaining one example of the processing that the scientific calculator 1 according to one embodiment of the present invention performs. The processing that the scientific calculator 1 performs in a case where a function (a performance feature) of solving the problem concerned in the workbook and a function (a performance feature) of displaying the learning progress information are allocated to the learning key 280 is illustrated in FIG. 3.

In a case where the learning key 280 is pressed, the scientific calculator 1 displays a selection screen for making the user select either setting of a problem from the workbook or display of the learning progress information (step S1) and decides which one is selected between setting of the problem setting and display of the learning progress information (step S2). In step S1, the control unit 100 (more specifically, the display processing section 102) makes the display unit 130 display the selection screen. The control unit 100 (more specifically, for example, the answer processing section 103) makes the decision in step S2. In a case where display of the learning progress information is selected (step S2: LEARNING PROGRESS INFORMATION DISPLAY), the scientific calculator 1 displays the learning progress information which is based on the result list 114 (step S11) and terminates execution of the processing. In step S11, the control unit 100 reads the result list 114 out of the storage unit 110 and makes the display unit 130 display the learning progress information which is based on the read-out result list 114. More specifically, for example, the answer processing section 103 reads out the result list 114 and the display processing section 102 displays the learning progress information on the display unit 130.

On the other hand, in a case where setting of the problem is selected on the selection screen (step S2: PROBLEM SETTING), the scientific calculator 1 displays the problem which is set (step S3) and decides presence/absence of a key-input operation (step S4). In step S3, the control unit 100 reads that problem out of the workbook 113 which is stored in the storage unit 110 and makes the display unit 130 display the read-out problem. More specifically, for example, the answer processing section 103 reads out the problem and the display processing section 102 displays the problem on the display unit 130. In step S3, either the user of the scientific calculator 1 may be able to select that problem or the scientific calculator 1 may select the problem in accordance with a predetermined problem setting rule or randomly. The control unit 100 makes the decision in step S4 until accepting the key-input operation for inputting the calculation formula which is used for solving that problem after making the display unit 130 display that problem (step S4: NO).

Ina case where the key-input operation is accepted after displaying of that problem (step S4: YES), the scientific calculator 1 decides whether the accepted key-input operation is an operation of inputting the equal key (“=”) 230 (step S5). The control unit 100 (more specifically, for example, the calculation processing section 101) makes the decision in step S5.

In a case where the equal key 230 is not input (step S5: NO), next, the scientific calculator 1 decides whether an input interval is being measured (step S6). The control unit 100 (more specifically, the answer processing section 103) makes the decision in step S6. In a case where the time interval between the key-input operations is being measured by the time counting unit 140, the control unit 100 decides that the input interval is being measured.

In a case where the input interval is not being measured (step S6: NO), the scientific calculator 1 holds input information which corresponds to the accepted key-input operation and starts measurement of the input interval (step S7). In step S7, for example, the control unit 100 (more specifically, the answer processing section 103) holds the input information and makes the time counting unit 140 start execution of a time counting process.

In a case where the input interval is being measured (step S6: YES), the scientific calculator 1 holds the input information and the input interval which correspond to the accepted key-input operations and resets measurement of the input interval (step S8). In step S8, the control unit 100 (more specifically, for example, the answer processing section 103) acquires information on the time which is being measured from the time counting unit 140 and holds a time interval between two pieces of information which are derived on the basis of the acquired time information as the input interval in a state of being correlated with the input information. In addition, in step S8, the control unit 100 (more specifically, the answer processing section 103) makes the time counting unit 140 reset time counting.

At the completion of execution of the process in step S7 or S8, the scientific calculator 1 returns to step S4 and decides presence/absence of the key-input operation. Then, since measurement of the input interval is completed, the scientific calculator 1 repeats execution of the process in step S8 every time that the key-input operation is accepted until inputting of the equal key 230 is accepted.

When accepting inputting of the equal key 230, the above-described decision result in step S5 is changed to YES. When accepting inputting of the equal key 230, the scientific calculator 1 displays a result of the calculation which is performed in accordance with the input calculation formula and a result of correct/incorrect decision and updates the result list 114 (step S9). In step S9, the control unit 100 performs the calculation in accordance with the input calculation formula and decides whether the result of the calculation which is performed is correct or incorrect and then makes the display unit 130 display the result of the calculation and the result (“correct” or “incorrect”) of correct/incorrect decision. The calculation processing section 101 performs the calculation in accordance with the input calculation formula. The answer processing section 103 decides whether the calculation result is correct or incorrect. The answer processing section 103 compares information on an answer to the problem that the learner solves with the result of the calculation that the calculation processing section 101 performs and decides whether the answer is correct or incorrect. The display processing section 102 performs a process of displaying the calculation result and the result of correct/incorrect decision on the display unit 130. The display processing section 102 makes the display unit 130 display a screen which contains, for example, the problem, the result of the calculation that the calculation processing section 101 performs and the result (for example, “correct” or “incorrect”) of correct/incorrect decision that the answer processing section 103 makes. In addition, in step S9, the control unit 100 updates the result list 114 which is stored in the storage unit 110. The answer processing section 103 updates the result list 114. The answer processing section 103 registers information (result information) which is correlated with the learner's level of understanding a predetermined function which is contained in the input calculation formula on the basis of the input information and the input interval, and the result of correct/incorrect decision that the answer processing section 103 holds on the result list 114. For example, the answer processing section 103 registers time information which is obtained by weighting the input interval that the predetermined function which is contained in the calculation formula is input on the basis of the result of correct/incorrect decision on the result list 114 as result information.

Following step S9, the scientific calculator 1 decides whether the next problem is to be displayed (step S10). The control unit 100 (more specifically, the answer processing section 103) makes the decision in step S10. For example, in a case where the user of the scientific calculator 1 presses a key which is correlated with display of the next problem, the control unit 100 decides to display the next problem. In a case where it is decided to display the next problem (step S10: YES), the scientific calculator 1 returns to step S3 and displays the next problem. In a case where it is decided not to display the next problem (step S10: NO), the scientific calculator 1 terminates execution of the processing in FIG. 3.

The scientific calculator 1 according to one embodiment of the present invention measures the time interval between the key-input operations in the course that the calculation formula for solving the selected problem is input in this way. Since it becomes possible for a learner who is high in the level of understanding the function which is used for solving the selected problem to input the calculation formula more smoothly than a learner who is low in the function understanding level, the time interval between the key-input operations that the learner who is high in the function understanding level performs becomes relatively short. In addition, as will be described later, in the scientific calculator 1 according to one embodiment of the present invention, in a case where the answer to the selected problem is incorrect, the information which is used for decision of the understanding level is weighted in such a manner that the understanding level becomes lower than the level which is achieved in a case where the answer is correct by a method of making a time which is taken to input the predetermined function longer than the measured time and so forth. Even in a case where the time interval between the key-input operations is short, it becomes possible to decide that the understanding level of the learner is low when the answer is incorrect by weighting the information in this way. Therefore, in the scientific calculator 1 according to one embodiment of the present invention, it becomes possible to decide the learner's level of understanding that function on the basis of information on the time which is taken to input that function when inputting the calculation formula. In other words, in the scientific calculator 1 according to one embodiment of the present invention, it becomes possible to decide and analyze the learner's understanding level in a thinking course (for example, thinking about what kind of calculation formula is used for solving the problem and so forth). Further, in the scientific calculator 1 according to one embodiment of the present invention, it becomes possible to display the learning progress information which indicates the learner's level of understanding the predetermined function in a time series on the display unit 130 by storing information on the time which is taken to input the predetermined function into the storage unit 110 as the result list 114.

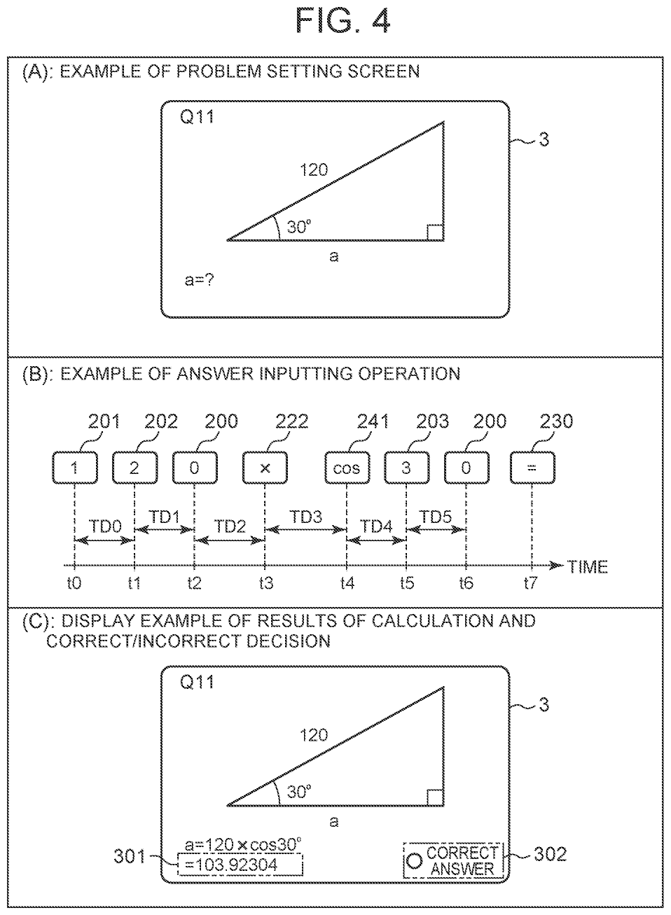

FIG. 4 is a diagram explaining one example of a learning method which is carried out by using the scientific calculator according to one embodiment of the present invention. In FIG. 4, (A) illustrates one example of a problem setting screen which is displayed on the display 3 of the scientific calculator 1. In FIG. 4, (B) illustrates one example of an answer inputting operation when solving the problem which is displayed on the display 3 in (A). In FIG. 4, (C) illustrates one example that the calculation result and the correct/incorrect decision result are displayed on the display 3.

In a case where the learner selects to set one problem from the problems in the workbook by pressing the learning key 280 on the scientific calculator 1 (step S2: PROBLEM SETTING), the problem of finding a length “a” of the adjacent side which has a 30-degree angle relative to the hypotenuse of a right-angled triangle such as, for example, the right-angled triangle which is illustrated in (A) in FIG. 4 is displayed on the display 3 of the scientific calculator 1. The calculation formula which is used to solve this problem is expressed by the following numerical formula (1).

a=120×cos 30° (1)

The learner who understands the trigonometric functions inputs the right side of the numerical formula (1) into the scientific calculator 1 as shown in (B) in FIG. 4 in order to solve the problem. Specifically, the learner inputs the calculation formula by pressing the 1-input key 201, the 2-input key 202, the 0-input key 200, the multiplication key 222, the cos-key 241, the 3-input key 203 and the 0-input key 200 in this order (here, it is assumed that the scientific calculator 1 is set to calculate 0 in cos 0 in degrees))(°. In this case, since the scientific calculator 1 according to one embodiment of the present invention performs the processing which is described above with reference to FIG. 3 and therefore holds time intervals TD0 to TD5 between the key-input operations together with the input information. Lengths of the time intervals TD0, TD1 and TD5 between keys which are used for inputting the numerical values are hardly influenced by a difference between the understanding levels of the learners. However, a length of the time interval TD2 which is taken from when “0” is input to when “×” is input and a length of the time interval TD3 which is taken from when “×” is input to when “cos” is input are easily influenced by the difference between the understanding levels of the learners to the trigonometric functions. In general, the time intervals TD2 and TD3 which are taken when the learner who is low in the level of understanding the trigonometric functions inputs the calculation formula become longer than the time intervals TD2 and TD3 which are taken when the learner who sufficiently understands the trigonometric functions inputs the calculation formula.

In a case where the learner inputs the calculation formula and then presses the equal key 230, the scientific calculator 1 performs the calculation in accordance with the calculation formula and decides whether the calculation result is correct or incorrect, and then displays the calculation result and the correct/incorrect decision result on the display 3 (step S9). In a case where the correct calculation formula such as the formula which is illustrated in (B) in FIG. 4 is input, the calculation result and the correct/incorrect decision result are displayed respectively in a region 301 and a region 302 which are located under a region that the problem is displayed on the display 3, for example, as illustrated in (C) in FIG. 4. In a case where the calculation result is correct, the scientific calculator 1 registers the time interval TD3 which is measured from when “×” is input to when “cos” is input on the result list 114 in a state of being correlated with that the calculation result is correct, for example, as information which indicates the learner's level of understanding Cosine (cos).

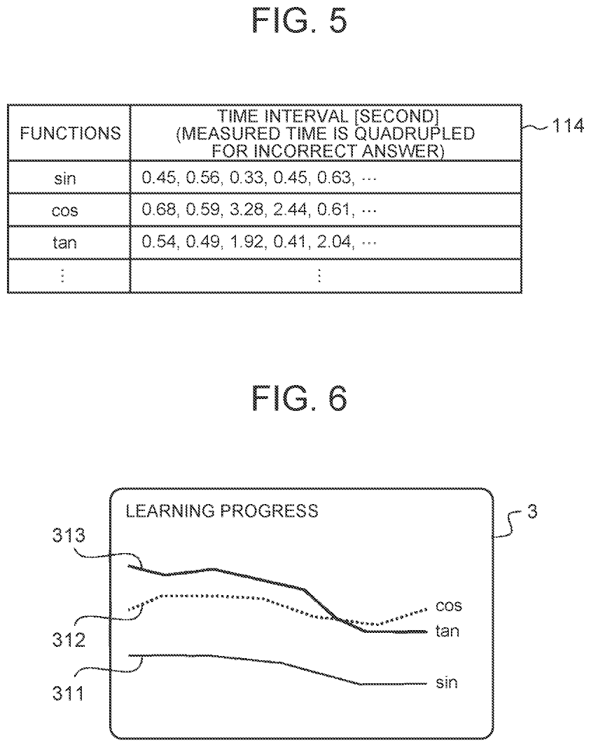

FIG. 5 is a diagram showing one example of the result list. A history of the time interval between the key-input operations (in seconds) which is measured when inputting the calculation formula which contains the function concerned is recorded in (registered on) the result list 114 which is exemplarily shown in FIG. 5, for every function which is listed as each learner's understanding level decision object.

In the result list 114 which is exemplarily shown in FIG. 5, the time interval which is recorded on the basis of the calculation result is weighted. Specifically, in a case where the calculation result is correct, the time interval which is measured by the time counting unit 140 is recorded and, in a case where the calculation result is incorrect, a time interval which is obtained by quadrupling the time interval which is measured by the time counting unit 140 is recorded. For example, in the time intervals which are measured for Cosine (cos), the time interval which is 3.28 sec. indicates that the time interval which is measured by the time counting unit 140 is 3.28 sec. and the calculation result is correct or indicates that the time interval which is measured by the time counting unit 140 is 0.82 sec. and the calculation result is incorrect. However, in either case, this time interval is sufficiently longer than the time intervals such as 0.68 sec., 0.59 sec. and so forth and therefore it becomes possible for the learner to decide that the his/her level of understanding Cosine (cos) is low.

In weighting to the time interval which is performed in a case where the calculation result is incorrect, the weight may be changed depending on, for example, at which part of the calculation formula which is input an error occurs (whether that calculation formula is different from the calculation formula the calculation result of which is correct). For example, only in a case where a function which is the understanding level decision object in the calculation formula which is input is different from the function which is to be originally input (for example, a case where Sine is input into a part that Cosine is to be originally input and so forth), the time interval may be quadrupled and in a case where the error occurs at a part which is not the function part (for example, a numerical-value part), the time interval which is measured by the time counting unit 140 may be recorded into the result list 114. In addition, for example, a weighted value to be added in the case where the function which is the learner's understanding level decision object in the input calculation formula is different from the function which is to be originally input (for example, the case where Sine is input into the part that Cosine is to be originally input) may be made larger than a weighted value to be added in the case where the error occurs at the part which is not the function part (for example, the numerical-value part).

Incidentally, information which is to be recorded into (registered on) the result list 114 may be another information which is available for decision of the learner's level of understanding the predetermined function, not limited to the time interval which is descried above with reference to FIG. 5. For example, a combination of the time interval which is measured by the time counting unit 140 and information which indicates the result of correct/incorrect decision (whether the calculation result is correct or incorrect) may be recorded into the result list 114. For example, a score which is derived on the basis of the time interval which is measured by the time counting unit 140 and the correct/incorrect decision result may be also recorded into the result list 114.

Further, the information which is to be recorded into the result list 114 may be also information which is derived on the basis of, for example, the time interval, the correct/incorrect decision result and a difficulty degree of each problem.

It becomes possible for the user (learner) of the scientific calculator 1 to make the display unit 130 (the display 3) display the learning progress information which is based on the result list 114 as described above. The learning progress information may be either information on, for example, the time interval and so forth which are measured when inputting the function which is selected from the functions in the result list 114 or another information which is derived on the basis of the information on the time interval and so forth. The learning progress information may be also, for example, information that the information on the time interval and so forth which are recorded in the result list 114 is graphed. In addition, the learning progress information may be also, for example, information that a moving average of time intervals which are derived on the basis of respective time intervals between the respective key-input operations which are recorded in the result list 114 is graphed.

FIG. 6 is a diagram illustrating a display example of the learning progress information. As one example of the learning progress information which is to be displayed on the display 3 of the scientific calculator 1, information that moving averages 311, 312 and 313 which are derived on the basis of the time intervals which are recorded in the result list 114 for Sine (sin), Cosine (cos) and Tangent (tan) are graphed is illustrated in FIG. 6.

In the learning progress information which is illustrated in FIG. 6, the moving averages 311 and 313 for Sine and Tangent are gradually lowered as the problem is solved and, on the other hand, the moving average 312 for Cosine rises right before further falling. It becomes possible for the learner who sees such leaning progress information (the moving averages 311, 312 and 313) to grasp (decide) that, for example, the learner's level of understanding Cosine is insufficient in comparison with the learner's levels of understanding Sine and Tangent and thereby it becomes possible for the learner to preferentially perform learning for understanding Cosine.

Incidentally, the learning progress information which is displayed on the display 3 of the scientific calculator 1 may be another information which is available for the learner to grasp (decide) his/her level of understanding the predetermined function, not limited to the moving averages which are described above with reference to FIG. 6.

The above-described embodiment merely indicates a concrete example for ready understanding of the present invention and the present invention is not limited to the above-described embodiment. It is possible to alter and modify the information processing device, the controlling method and the recording medium in a variety of ways within the range not deviating from the scope of patent claims of the present invention.

For example, it is possible to change a method of measuring the time interval between the key-input operations in the calculation formula which is input when solving the selected problem in accordance with an input system of the calculation formula (in particular, the function part) in the scientific calculator 1. In addition, in a case where an operation of cancelling the key-input operation is performed while the calculation formula is being input, the control unit 100 of the scientific calculator 1 may delete (clear) the input information which is deleted from the calculation formula and the time interval between the key-input operations which is correlated with that input information. In addition, in a case where an operation of cancelling the key-input operation for the predetermined function is performed while the calculation formula is being input, the control unit 100 of the scientific calculator 1 may hold the input information on that key-input operation and the time interval between the key-input operations and may reflect that input information and that time interval which are held on information which is to be recorded into the result list 114. There are cases where when inputting the calculation formula for solving the above-described problem with reference to FIG. 4, for example, the learner who is low in the level of understanding the trigonometric functions becomes aware of a function input error after inputting “120×sin”, deletes “sin” and then inputs “cos”. In such a case, a key-input operation for deleting “sin” is performed immediately before inputting “cos” and therefore the time interval which is to be correlated with inputting of “cos” becomes shorter. However, since the learner mistakes “sin” for “cos”, it is difficult to say that the learner's understanding level is sufficiently high even when the learner solves the problem correctly. For this reason, even in a case where the learner solves the problem correctly, the fact that the learner inputs another function by mistake while inputting the calculation formula is reflected on time information which is to be recorded into the result list 114. For example, in a case of the above-described example that in a case where the answer is incorrect, the time interval is quadrupled, when although the learner solves the problem correctly, the learner inputs another function by mistake while inputting the calculation formula, the time interval is doubled. Thereby, since a difference is made between the above-mentioned case and a care where the learner inputs the correct function with no mistake and solves the problem correctly and this difference is reflected on the learning progress information, it becomes possible for the learner to recognize (grasp) that he/she does not yet sufficiently understand the trigonometric functions.

In addition, the scientific calculator 1 may include a communication unit which controls communications with external terminals in addition to the control unit 100, the storage unit 110, the input unit 120, the display unit 130 and the time counting unit 140 which are illustrated in FIG. 2. The communication unit may be a wireless communication interface which is communicable with the external terminals through wireless communications which conform to well-known short distance wireless communication standards such as, for example, BLE (Bluetooth Low Energy (the registered trademark) and so forth. In addition, the communication unit may be a communication interface (an input/output interface) which is connected to be communicable with the external terminals via a transmission cable such as, for example, a USB (Universal Serial Bus) cable and so forth. It becomes possible for the scientific calculator 1 which includes the communication unit to perform, for example, acquisition of workbook(s) from the external terminal(s), transmission of the result list 114 to the external terminal(s), acquisition of a detailed analysis result of the learner's understanding level which is performed by the external terminal on the basis of the result list 114 and so forth. Thereby, it becomes possible, for example, to update the workbook 113 of the scientific calculator 1 to a workbook of a difficulty degree which accords with the learner's understanding level.

In addition, for example, when selecting one problem and displaying the problem on the display unit 130 (the display 3), it may become possible for the scientific calculator 1 to preferentially select a problem which is to be solved by using a calculation formula which contains a function the learner's understanding level to which is relatively low.

In addition, the workbook 112 may contain problems which are available for learning (practicing) of an operation method such as, for example, a method of inputting the calculation formula and so forth into the scientific calculator 1, not limited to problems which are available for learning of subjects such as mathematics and so forth, certificate examinations and so forth. It becomes possible for the user of the scientific calculator 1 to eliminate at an early stage such a disadvantage that, for example, for reasons that the user learns key arrangements which are different for different manufactures and types, a method of inputting functions and so forth at the early stage and is unaccustomed to operations consequently, the time interval between the key-input operations is increased (it is decided that the user is low in understanding level) by containing the problems which are available for learning of the operation method.

In addition, the information processing device according to the present invention may be another type electronic device which has the functions (performance features) which are equivalent to the functions (performance features) of the scientific calculator 1 such as, for example, a smartphone, a tablet-type PC and so forth, each of which is operable as the scientific calculator by executing a program which contains the processing which is illustrated in FIG. 3, not limited to the scientific calculator 1 which is described above with reference to the drawings.

What is claimed is:

1. An information processing device comprising:
a storage unit which has a first storage area for storing a workbook which contains problems which are to be solved by using a calculation formula which contains a function and correct answers to each of the problems;
a time counting unit which measures a time interval between two pieces of input information which are input in a case where one calculation formula which is used for solving one problem which is selected from the problems in the workbook is input by an input unit; and
at least one control unit which makes a display unit display learning progress information which indicates a level of understanding the function on the basis of the time interval between the input information which indicates the function which is contained in the calculation formula and the input information which is input before inputting of that input information.

2. The information processing device according to claim 1, wherein
in a case where a result of a calculation which is performed in accordance with the input calculation formula is incorrect, the at least one control unit makes the display unit display learning progress information that the level of understanding the function is made lower than a level which is achieved in a case where the calculation result is correct.

3. The information processing device according to claim 2, wherein
in the case where the result of the calculation which is performed in accordance with the input calculation formula is incorrect, the at least one control unit makes the time interval between the input information which indicates the function which is contained in the calculation formula and the input information which is input before inputting of that input information longer than a time interval which is obtained in a case where the calculation result is correct and thereby lowers the level of understanding the function.

4. The information processing device according to claim 1, wherein
every time that each calculation is performed in accordance with each calculation formula which is used for solving each problem which is selected from the problems in the workbook,
the at least one control unit
makes the storage unit store the learning progress information which indicates the level of understanding the function into a second storage area thereof and
makes the display unit display the learning progress information which is stored in the second storage area in a time series.

5. The information processing device according to claim 1, wherein
the input unit includes a key for inputting a single-digit numerical value, a key for inputting an arithmetic operator and a key for inputting the function.

6. The information processing device according to claim 5, wherein
the information processing device is a scientific calculator that each key of the input unit is a hardware key.

7. The information processing device according to claim 1, wherein
the function contains trigonometric functions.

8. A controlling method comprising the steps of:
making a storage unit store a workbook which contains problems which are to be solved by using a calculation formula which contains a function and correct answers to each of the problems into a first storage area thereof;
measuring a time interval between two pieces of input information which are input in a case where one calculation formula which is used for solving one problem which is selected from the problems in the workbook is input by an input unit; and
making a display unit display learning progress information which indicates a level of understanding the function on the basis of the time interval between the input information which indicates the function which is contained in the calculation formula and the input information which is input before inputting of that input information.

9. The controlling method according to claim 8, further comprising the step of:
in a case where a result of a calculation which is performed in accordance with the input calculation formula is incorrect, making the display unit display learning progress information that the level of understanding the function is made lower than a level which is achieved in a case where the calculation result is correct.

10. The controlling method according to claim 9, further comprising the step of:
in the case where the result of the calculation which is performed in accordance with the input calculation formula is incorrect, making the time interval between the input information which indicates the function which is contained in the calculation formula and the input information which is input before inputting of that input information longer than a time interval which is obtained in a case where the calculation result is correct and thereby lowering the level of understanding the function.

11. The controlling method according to claim 8, further comprising the steps of:
every time that each calculation is performed in accordance with each calculation formula which is used for solving each problem which is selected from the problems in the workbook, making the storage unit store the learning progress information which indicates the level of understanding the function into a second storage area thereof; and
making the display unit display the learning progress information which is stored in the second storage area in the time series.

12. The controlling method according to claim 8, wherein
the input unit includes a key for inputting a single-digit numerical value, a key for inputting an arithmetic operator and a key for inputting the function.

13. The controlling method according to claim 8, wherein
the function contains trigonometric functions.

14. A non-transitory computer-readable recording medium for recording a program which is executable by at least one control unit in an information processing device which includes a storage unit, wherein
the storage unit includes a first storage area for storing a workbook which contains problems which are to be solved by using a calculation formula which contains a function and correct answers to each of the problems, and
the at least one control unit
makes a time counting unit measure a time interval between two pieces of input information which are input in a case where one calculation formula which is used for solving one problem which is selected from the problems in the workbook is input by an input unit and
makes a display unit display learning progress information which indicates a level of understanding the function on the basis of the time interval between the input information which indicates the function which is contained in the calculation formula and the input information which is input before inputting of that input information.

15. The recording medium according to claim 14, wherein
in a case where a result of a calculation which is performed in accordance with the input calculation formula is incorrect, the at least one control unit makes the display unit display learning progress information that the level of understanding the function is made lower than a level which is achieved in a case where the calculation result is correct.

16. The recording medium according to claim 15, wherein
in the case where the result of the calculation which is performed in accordance with the input calculation formula is incorrect, the at least one control unit makes the time interval between the input information which indicates the function which is contained in the calculation formula and the input information which is input before inputting of that input information longer than a time interval which is obtained in a case where the calculation result is correct and thereby lowers the level of understanding the function.

17. The recording medium according to claim 14, wherein
every time that each calculation is performed in accordance with each calculation formula which is used for solving each problem which is selected from the problems in the workbook,
the at least one control unit
makes the storage unit store the learning progress information which indicates the level of understanding the function into a second storage area thereof and
makes the display unit display the learning progress information which is stored in the second storage area in the time series.

18. The recording medium according to claim 14, wherein
the input unit includes a key for inputting a single-digit numerical value, a key for inputting an arithmetic operator and a key for inputting the function.

19. The recording medium according to claim 14, wherein
the information processing device is a scientific calculator that each key of the input unit is a hardware key.

20. The recording medium according to claim 14, wherein
the function contains trigonometric functions.
